(19) United States
(12) Patent Application Publication
(10) Pub. No.: US 2021/0161087 A1
(43) Pub. Date: Jun. 3, 2021

(54) SUSPENDED FLOWERPOT ADAPTED TO AUTOMATIC WATER SUPPLY

(71) Applicant: AGRICULTURAL CORPORATION GYERYONGCHIU AGRICULTURAL CO., LTD., Gyeryong-si, Chungcheongnam-do (KR)

(72) Inventor: Hyeon Jeong LEE, Gyeryong-si (KR)

(73) Assignee: AGRICULTURAL CORPORATION GYERYONGCHIU AGRICULTURAL CO., LTD., Gyeryong-si, Chungcheongnam-do (KR)

(21) Appl. No.: 17/262,718

(22) PCT Filed: Jul. 24, 2019
(86) PCT No.: PCT/KR2019/009141

§ 371 Date: Jan. 23, 2021

(30) Foreign Application Priority Data
Jul. 25, 2018 (KR) 10-2018-0086732

(51) Int. Cl. A01G 27/00; A01G 9/02

(52) U.S. Cl. CPC A01G 27/003; A01G 27/005; A01G 9/027; A01G 9/023; A01G 9/024; A01G 27/008

(57) ABSTRACT

The present invention relates to a suspended flowerpot adapted to automatic water supply and, more specifically, to a plant cultivation system wherein multiple flowerpots can be suspended on a horizontal member, and the system has a water supply structure enabling automatic water supply to the flowerpots by means of buoyancy, thereby facilitating management for plant cultivation. The present invention, as described above, comprises: at least one flowerpot comprising a mounting portion that can be suspended on a horizontal member, and a body portion having a containing space therein and having a water supply hole in the lower portion thereof; a plant planting portion having an open supper portion through which soil and plants are contained therein, the planting portion being contained in the flowerpot; and a water supply portion having a water storage space for storing water supplied from the outside, having a drain hole formed in the lower portion of the water storage space such that a water supply hose connected to the water supply hole is mounted therein, and having a buoyancy opening/closing portion driven by buoyancy according to the water level, thereby opening/closing the water supply hole.

### FIELD OF INVENTION

The present invention relates to a suspended flowerpot adapted to automatically supply water and, more particularly, to a plant cultivation system having a horizontal member from which multiple flowerpots can be suspended, as well as a water supply structure enabling automatic water supply to the flowerpots through buoyancy, thereby facilitating management of plant cultivation.

### BACKGROUND OF INVENTION

Recently, as problems due to fine dusts have emerged, demand for plants is increasing to obtain indoor air purification effects and psychological stability effects, and plants are cultivated in many commercial spaces to create a nature-friendly atmosphere in an urban environment.

As such, the demand for plants is gradually increasing and interiors using plants are also in the spotlight. An interior using plants may be called a “planterior”, and it is very important for the planterior to keep the indoor environment in the best condition by utilizing the space and maintaining the plants consistently.

However, as the structure and shape of the interior space are very diverse, arrangement of potted plants planted for interiors in dimension-limited spaces not only reduces the interior space but also has a limitation that a flowerpot is typically placed on the floor due to the structure thereof. Due to difficulties in using the interior with a balustrade such as on a balcony, there was a limitation in realization of interior diversity.

In addition, regular watering is a very important factor in plant cultivation. If watering is not carried out on time, the plants will wither or die, thus having aesthetically adverse effects.

As a conventional technology for solving this problem, Korean Patent Laid-Open Publication No. 10-2018-0046623, entitled “Multi-stage plant cultivation apparatus with improved water supply structure”, has disclosed a multi-stage plant cultivation apparatus having an improved water supply structure wherein a variety of plants can be grown in a narrow space.

Such a plant cultivation apparatus as described above is a cultivation apparatus enabling cultivation of multiple flowerpots in a narrow space, wherein water is supplied up and down so that, when an upper planting pot reaches a water storage level meeting a set level, additionally supplied water flows to a lower planting pot, thereby achieving the above cultivation apparatus.

However, the prior art described above has a problem in that the plant can be planted only within a limited plant pot, and a space provided for placing the pot is restricted, therefore, there are difficulties in preparing creative spaces for arrangement of flowerpots and further implementing arrangement of additional flowerpots rather than the designed planting pots. Moreover, there is a limitation that the flowerpots may be dropped and broken due to external impact.

In addition, when the planted plant dies or needs to be separated from the pot due to rapid growth, the soil covering the plant, which has been grown for a long time in the pot, is rigid or hardened and thus is not easy to separate from the plant.

### PRIOR ART LITERATURE

### Patent Document

(Patent Document 0001) Korean Patent Laid-Open Publication No. 10-2018-0046623 (20180509)

### SUMMARY OF INVENTION

### Technical Problem to be Solved

The present disclosure has been designed to overcome the aforementioned problems, and an object of the present invention is to provide a suspended flowerpot enabling automatic water supply, that can be installed in a space with different morphologies and has a water supply structure to automatically supply water to the flowerpot (often referred to simply as “pot”) by adjusting a water level, thereby managing a number of pots conveniently.

### Technical Solution

In order to solve the above problems, the present invention provides a suspended flowerpot adapted to automatically supply water, which includes: at least one pot having a mounting part possibly suspended on a horizontal member, and a main body that has an accommodation space therein and is provided with a water supply hole formed on a lower portion thereof; a plant planting member (“planting member”) that has an open upper portion through which soil and plants are received and is made of a water-absorbable material, a lower portion of which is accommodated in the pot to be arranged at a lower position than the water supply hole; and a water supply member that has a water storage space to store water supplied from the outside, a drain hole formed on a lower portion of the water storage space, on which a water supply hose is mounted to be connected to the water supply hole, and a buoyancy switching member driven by buoyancy along the water level so as to open/close a feed hole.

In this regard, a plurality of flowerpots may be suspended from the horizontal member, and the water supply hose may include a first hose for connecting the water supply hole and the drain hole and a second hose for connecting the water supply hole between adjacent pots. Further, the water supply member preferably supplies water through the first hose and the second hose, such that the plurality of pots arranged at substantially the same height contains water to reach substantially the same water level.

Further, one or more pots may be suspended from multiple horizontal members arranged at different heights. It is preferable that the water supply members for pots suspended from corresponding horizontal members are mutually connected through a feed hose.

Further, a neck part narrowing to prevent leakage of the plant and soil contained in the planting member may be formed on the upper portion of the planting member, and a release preventing member connected to the mounting part of the pot while surrounding the outside of the neck part may further be provided.

In addition, a protrusion is preferably formed on an inner circumferential surface of the pot to prepare a gap with the planting member.

### Effect of Invention

The pot according to the present invention may arrange a plurality of plants in a small space and enable cultivation thereof by means of a horizontal member capable of suspending multiple pots, may also be utilized for pots on horizontal members having different heights, and can be installed in different spaces such as a flat surface or a curved surface through a coupling means such as a ring or string, thus enabling free arrangement. Therefore, there is an advantage of less restriction in structures, especially, in terms of installation space.

Further, the pot of the present invention is provided with a specific water supply structure using buoyancy to automatically supply water depending on a water level, thereby eliminating inconvenience of water supply at regular intervals. Further, the pot of the present invention enables easy management of a number of plants by adjusting the water level in the pot to prevent water overflow.

Further, the present invention has advantages that the neck part formed in the planting member to accommodate plant and soil can prevent outflow of the plant and soil and may facilitate transfer of the plant (or replanting) to another pot.

In addition, the present invention can achieve effects of feeding oxygen through a space between protrusions formed on an inner circumferential surface (“inner surface”) of the pot and controlling humidity, thereby configuring desired environments to allow plants to grow well.

### BRIEF DESCRIPTION OF DRAWINGS

FIG. 1 is a perspective view of the suspended pot adapted to automatically supply water (abbrev. to “suspended pot”) according to the present invention;

FIG. 2 is a perspective view illustrating an exploded state of FIG. 1;

FIG. 3 is a perspective view illustrating a state of the suspended pot installed on a pillar according to a first embodiment of the present invention;

FIG. 4 is a longitudinal cross-sectional view illustrating an installation structure of the plant cultivation system according to the present invention;

FIG. 5 is a longitudinal cross-sectional view illustrating a water supply structure of the plant cultivation system according to the present invention;

FIG. 6 illustrates the pot of the plant cultivation system according to the present invention, as viewed from the top;

FIG. 7 illustrates a state of use of the plant cultivation system according to the present invention; and

FIG. 8 is a perspective view illustrating a state of the pot installed on various horizontal members according to a second embodiment of the present invention.

### BEST MODE

Hereinafter, the configuration of the suspended pot according to the present invention will be described in detail with reference to the accompanying drawings.

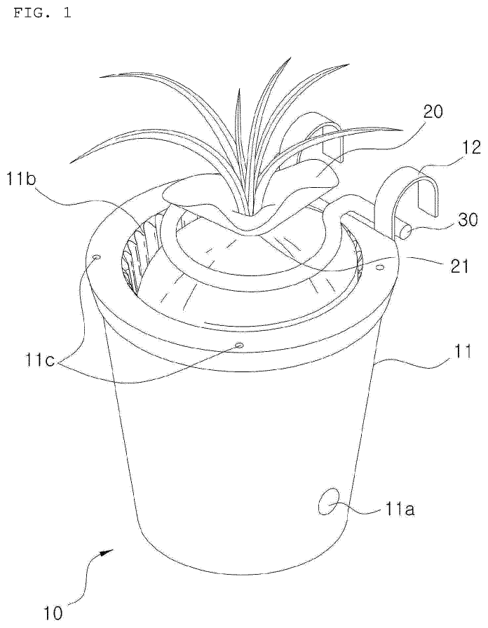

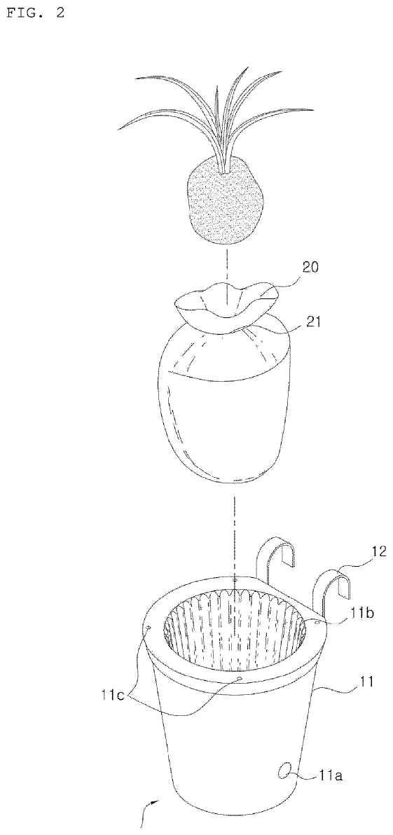

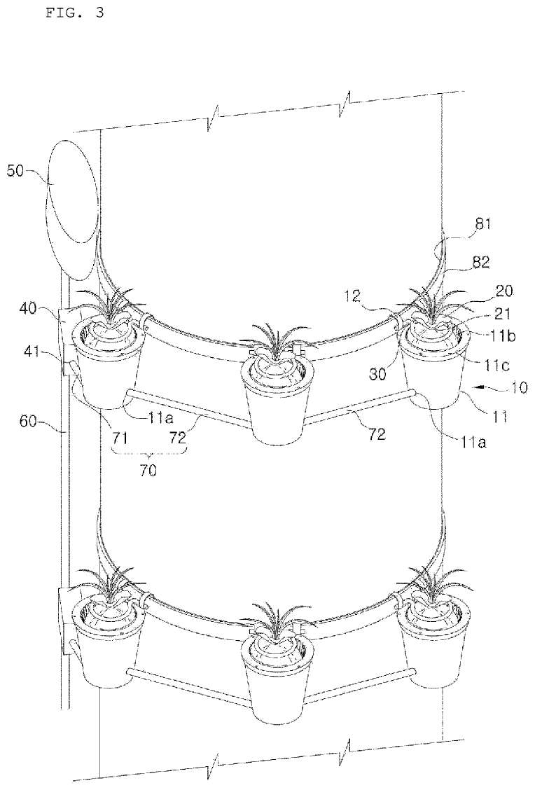

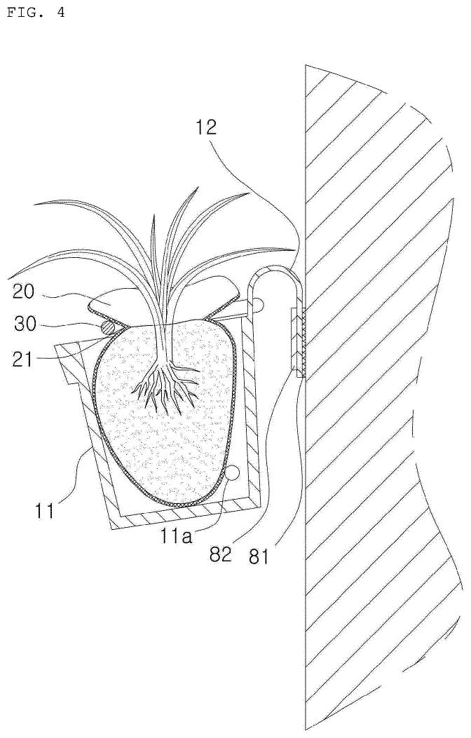

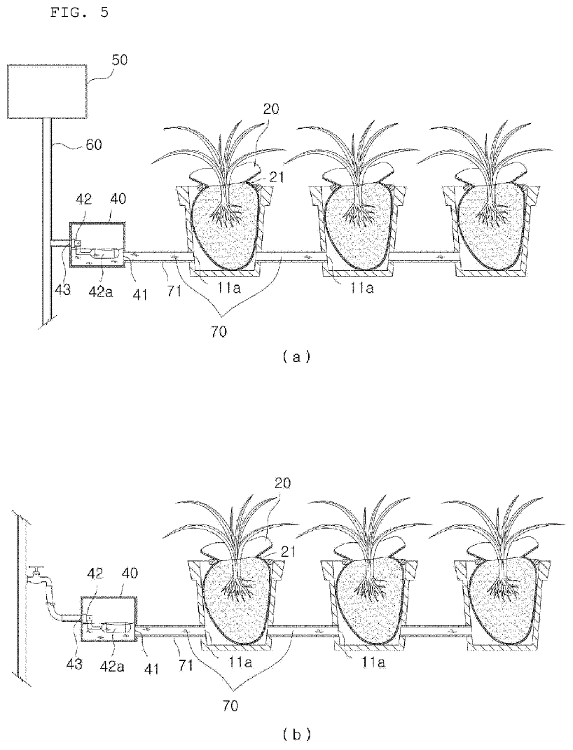

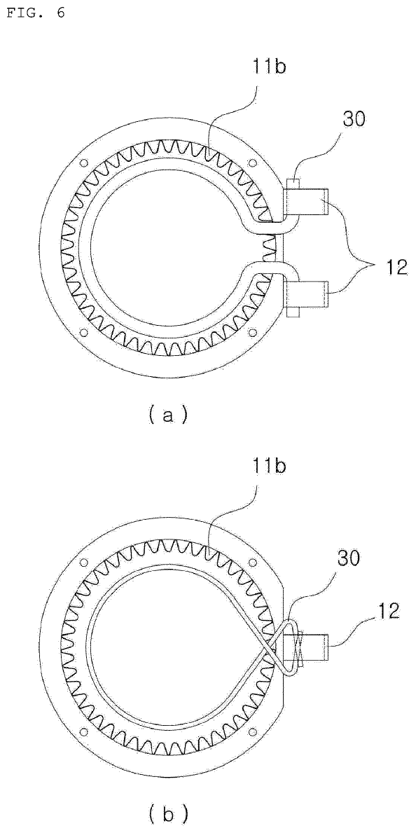

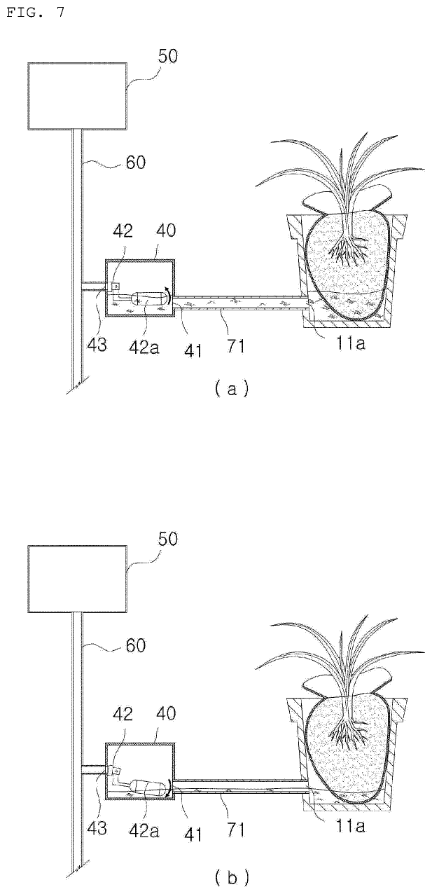

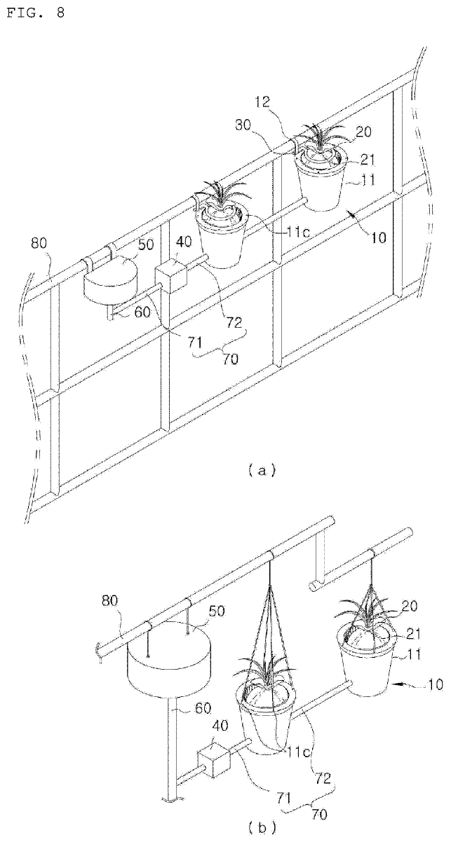

FIG. 1 is a perspective view of the suspended pot according to the present invention; FIG. 2 is a perspective view illustrating an exploded state of FIG. 1; FIG. 3 is a perspective view illustrating a state of the suspended pot installed on a pillar according to a first embodiment of the present invention; FIG. 4 is a longitudinal cross-sectional view illustrating an installation structure of the plant cultivation system according to the present invention; FIG. 5 is a longitudinal cross-sectional view illustrating a water supply structure of the plant cultivation system according to the present invention; FIG. 6 illustrates the pot of the plant cultivation system according to the present invention, as viewed from the top; FIG. 7 illustrates a state of use of the plant cultivation system according to the present invention; and FIG. 8 is a perspective view illustrating a state of the pot installed on various horizontal members according to a second embodiment of the present invention.

As shown in FIGS. 1 to 8, the present invention relates to a suspended pot adapted to automatically supply water, as a plant cultivation system facilitating plant cultivation and management, characterized in that multiple pots may be installed in a space of a horizontal member such as a balcony or a balustrade, and a pot with a lower water level may be automatically supplied with water by driving a ball valve according to a water level, thereby avoiding discomfort in water supply.

To this end, the plant cultivation system of the present invention basically consists of at least one pot 10 including a mounting part 12 and a main body 11, a planting member 20 to accommodate soil and plants, and a water supply member 40 to manage the supply of water.

The pot 10 may be provided with the mounting part 12 which can be suspended from a horizontal member 80 installed at substantially the same height, and the main body 11 having an accommodation space therein and a water supply hole 11a at a lower portion thereof.

The pot 10 may be disposed on the horizontal member having a variety of shapes. As shown in FIG. 1, the horizontal member may be a horizontal member fabricated by winding a wire 82 around a column or pillar. Alternatively, as shown in FIG. 8(a), a horizontal member on a handrail or balustrade having the same height may also be used. Further, as shown in FIG. 8(b), the horizontal member may be configured on a handrail having different heights.

With regard to the horizontal member 80 fabricated by winding the wire 82 around the pillar, in order to prevent the wire 82 from loosening down from the pillar and to prepare a space in which the mounting part 12 is fixed between the wire 82 and the pillar, the wire 82 is preferably installed while interposing a rubber packing 81 between the wire and the pillar.

At least one perforation type coupling hole 11c may be formed at the top of the main body 11 in order to suspend a ring or a string. In particular, in case of the horizontal member 80 of a handrail having different heights, the main body may be suspended with a string through the coupling hole 11c and a distance between the pot 10 and the horizontal member 80 may be regulated by adjusting a length of the string, so that the pot 10 is installed at the same height. Therefore, the water supply hose 70 connected between multiple pots 10 becomes horizontal so as to manage the multiple pots at the same water level.

In order to secure the pot 10 to the horizontal member 80, at least one mounting part 12 is formed on an upper side of the pot 10 in the form of ‘¬’, wherein, if a gap between the mounting part 12 and the main body 11 is too narrow, the configuration of an installation space is considerably restricted. Therefore, it is preferable to leave a margin in the above gap.

The main body 11 may have an accommodation space therein and may be provided with a water supply hole 11a connected to a drain hole 41 through the water supply hose 70 prepared on a lower side of the pot 10.

The water supply hole 11a may be formed in an empty space between the main body 11 and the planting member 20, in order to prevent a water channel from being blocked by soil in the planting member 20, thereby ensuring smooth water supply through the water supply hose 70.

The planting member 20 may accommodate the soil and the plant therein through an open upper portion, is formed in a bag shape and is placed in the pot 10 while containing the soil and the plant.

At this time, a lower portion of the planting member 20 is disposed at a lower position than the water supply hole 11a, so that the lower portion of the planting member 20 is submerged in the water supplied from the water supply hole 11a. Since the planting member 20 is made of a water-absorbable material, the planting member 20 may absorb water supplied from the water supply hole 11a and then feed the water to the accommodated soil and plant.

In general, when water is supplied to a pot having a water channel, soil is mixed with water and gradually stacked on the water channel to block the water channel, hence preventing smooth water supply. However, the planting member 20 may allow free entry of water simultaneously with absorbing water, while preventing discharge (or leakage) of soil. Therefore, the planting member 20 of the present invention may act as a filter to prevent occurrence of the aforementioned problems.

Further, when the pot 10 is suspended from the horizontal member 80 in a state in which the planting member 20 is installed in the pot 10, the pot 10 may be inclined. In this case, in order to prevent discharge of the plant and soil, a neck part 21 may be formed to be narrowed at a site where an upper portion of soil is located.

A release preventing member 30 connected to the mounting part 12 of the pot 10 while surrounding the outside of the neck part 21 may be formed in a ring shape with one side open, as shown in FIG. 6(a). When external force is applied to both ends of the open side, both ends with a narrowed gap may be inserted into two mounting parts 12 and then secured to the two mounting parts 12 by restoration force occurring simultaneously with removal of the external force.

At this time, the release preventing member 30 preferably consists of a wire having elasticity.

When having a configuration of two mounting parts 12, the release preventing member 30 may be formed in a ring shape having one open side as described above. On the other hand, in case of the release preventing member 30 configured with one mounting part 12, both ends thereof may intersect in an X-shape, as shown in FIG. 6(b).

In this case, applying a pulling force to the release preventing member 30 may induce deformation to surround the outside of the neck part 21. When the external force is removed, elastic force to restore to the original form is generated and both ends may intersect in an X-shape and be fixed on the only one mounting part 12.

Since the planting member 20 is stably secured to the pot through the release preventing member 30, the planting member 20 may not be separated and fall from the fixed position by external impact, may not arbitrarily break away by people, and may be protected from soil blowing or dripping.

The protrusion 11b may be formed on an inner surface of the pot 10 and is configured to form a gap with the planting member 20, wherein oxygen is fed through the gap and moisture is controlled to prevent over-humidity, thereby providing environments suitable for plant growth.

The water supply member 40 is provided with a water storage space to store water supplied from the outside, wherein a drain hole 41 is formed on a lower portion of the water storage space, and the water supply hose 70 connected to the water supply hole 11a is mounted on the drain hole 41.

The drain hole 41 is preferably formed at a position lower than a feed hole 43, which is diagonal to the feed hole 43, in order to smoothly supply water.

The feed hole 43 formed at the left side of the water supply member 40 is equipped with a feed hose 60 connected to a feed unit 50, while the drain hole 41 formed at the right side of the water supply member 40 is equipped with a water supply hose 70 connected to the water supply hole 11a. Further, a buoyancy switching member 42 to open/close the feed hole 43 by driving a ball valve 42a according to a water level in the water supply member 40 may be provided.

The water supply member 40 receives water from the feed unit 50 through the feed hose 60, and the ball valve 42a provided in the water supply member 40 extends toward the buoyancy switching member 42. As the ball valve 42a moves up and down according to a water level of the water supply member 40, water supply may be managed and the water level may be controlled through the buoyancy switching member 42 to close or open the feed hole 43 connected to the feed hose 60.

On the other hand, the present invention may not include the feed unit 50 as shown in FIG. 5(b) and, instead, may directly supply water to the water supply member 40 by directly connecting the feed hose 60 to a water pipe.

The water supply hose 70 may include a first hose 71 to connect the water supply hole 11a and the drain hole 41, and a second hose 72 to connect the water supply hole 11a between adjacent pots 10.

The first hose 71 supplies water to the pot 10 from the water supply member 40 while the second hose 72 supplies water to the adjacent pot, so that water can be supplied to a plurality of flowerpots disposed at substantially the same height through the first hose 71 and the second hose 72 so as to reach substantially the same water level.

Since the water supply members 40 of one or more pots suspended from a plurality of horizontal members 80 arranged at different heights are configured to be mutually connected though the feed hose 60, water may be supplied to the water supply member 40 on each of the horizontal members having different heights through the feed hose 60.

In description of water supply operation of the plant cultivation system according to the present invention, as shown in FIG. 7, water fed from the outside to the feed unit 50 may be supplied to the water supply member 40 through the feed hose 60. Herein, a water level may be controlled using a buoyancy switching member 42 to open and close the feed hole 43 connected to the feed hose 60 by driving the ball valve 42a of the water supply member 40.

When the water level of the water supply member 40 is higher than a reference water level, as shown in FIG. 7(a), the ball valve 42a connected to the buoyancy switching member 42 moves upward to close the buoyancy switching member 42, so that water supply from the feed hose 60 is stopped. Therefore, the water supply member 40 is driven by the ball valve 42a of the water supply member 40 and may receive water only up to the reference water level from the feed unit 50, so that water supplied to the water supply member 40 is delivered to the pots having a lower water level than a height of the first hose 71 through the first hose 71, followed by delivering water between the pots through the second hose 72. Accordingly, the plurality of pots is supplied with water to reach the same water level.

When the water level of the water supply member 40 is lowered by supplying water to the pot 10, the ball valve 42a moves downward as shown in FIG. 7(b) to open an upper side of the buoyancy switching member 42, which in turn opens the feed hole 43, so that water is fed from the feed hose 60 to manage the water level of the water supply member 40, thereby enabling automatic water supply.

Therefore, the plant cultivation system of the present invention can automatically supply water to pots through an automatic water supply structure in order to maintain a predetermined water level, thereby reducing inconvenience in water supply and allowing easy cultivation of a plurality of plants.

As described above, subject matters of the present invention are not limited to the embodiments described above, but are defined by the claims, and it will be apparent that various modifications and adaptations are possibly implemented within the scope of the appended claims by those skilled in the art.

### DESCRIPTION OF REFERENCE NUMERALS

10: Flowerpot (or pot) 11: Main body

11a: Water supply hole 11b: Protrusion

11c: Coupling hole 12: Mounting part

20: Planting member 21: Neck part

30: Release preventing member 40: Water supply member

41: Drain hole 42: Buoyancy switching member

42a: Ball valve 43: Feed hole

50: Feed unit 60: Feed hose

70: Water supply hose 71: First hose

72: Second hose 80: Horizontal member

81: Rubber packing 82: Wire

### DETAILED DESCRIPTION OF PREFERRED EMBODIMENTS OF INVENTION

Provided herewith is a suspended flowerpot adapted to automatically supply water, including: at least one pot 10 which has a mounting part 12 suspended from a horizontal member 80 installed at substantially the same height, and a main body 11 that has an accommodation space therein and is provided with a water supply hole 11a on a lower portion thereof;

a planting member 20 that has an open upper portion through which soil and a plant are received and is made of a water-absorbable material, a lower portion of which is accommodated in the pot 10 to be arranged at a lower position than the water supply hole 11a; and
a water supply member 40 that has a water storage space to store water supplied from the outside, a drain hole 41 formed on a lower portion of the water storage space on which a water supply hose 70 is mounted to be connected to the water supply hole 11a, and a buoyancy switching member 42 driven by buoyancy according to the water level so as to open/close a feed hole 43.

1. A suspended flowerpot adapted to automatically supply water, comprising:
at least one pot 10 which has a mounting part 12 suspended from a horizontal member 80 installed at substantially the same height, and a main body 11 that has an accommodation space therein and is provided with a water supply hole 11a on a lower portion thereof;
a planting member 20 that has an open upper portion through which soil and a plant are received and is made of a water-absorbable material, a lower portion of which is accommodated in the pot 10 to be arranged at a lower position than the water supply hole 11a; and
a water supply member 40 that has a water storage space to store water supplied from an outside of the water supply member, a drain hole 41 formed on a lower portion of the water storage space on which a water supply hose 70 is mounted to be connected to the water supply hole 11a, and a buoyancy switching member 42 driven by buoyancy depending upon the water level so as to open/close a feed hole 43.

2. The suspended flowerpot according to claim 1, wherein a plurality of flowerpots 10 is suspended from the horizontal member 80, and the water supply hose 70 includes: a first hose 71 for connecting the water supply hole 11a and the drain hole 41 and a second hose 72 for connecting the water supply hole 11a between adjacent pots 10, and wherein the water supply member 40 supplies water through the first hose 71 and the second hose 72 such that the plurality of pots 10 arranged at substantially the same height contains water to reach substantially the same water level.

3. The suspended pot according to claim 2, wherein one or more pots 10 are suspended from multiple horizontal members 80 arranged at different heights, and the water supply members 40 for the pots 10 suspended from corresponding horizontal members 80 are connected through the feed hose 60.

4. The suspended pot according to claim 1, wherein a neck part 21 narrowing to prevent leakage of the plant and soil contained therein is disposed on top of the planting member 20, and a release preventing member 30 connected to the mounting part 12 of the pot 10 while surrounding an outside of the neck part 21 is further provided.

5. The suspended pot according to claim 1, wherein a protrusion 11b is formed on an inner circumferential surface of the pot 10 to form a gap with the planting member 20.
